(19) United States
(12) Patent Application Publication
(10) Pub. No.: US 2021/0304084 A1
(43) Pub. Date: Sep. 30, 2021

(54) LOUNGE CHAIR RESERVATION SYSTEM AND DESTINATION RECOMMENDATION SYSTEM

(71) Applicant: Rose Angela MARAZITA, Hewlett Harbor, NY (US)

(72) Inventor: Rose Angela MARAZITA, Hewlett Harbor, NY (US)

(21) Appl. No.: 17/265,282

(22) PCT Filed: Aug. 20, 2019
(86) PCT No.: PCT/US2019/047224

§ 371 Date: Feb. 2, 2021

Related U.S. Application Data
(60) Provisional application No. 62/719,889, filed on Aug. 20, 2018.

(51) Int. Cl. G06Q 10/02; G06Q 50/12; G06F 3/0484

(52) U.S. Cl. CPC G06Q 10/02; G06F 3/04842; G06Q 50/12

(57) ABSTRACT

Disclosed herein is a lounge chair reservation system used for reserving lounge chairs, or other seating options, at a destination. A layout screen allows a user to see the positioning of the lounge chairs in conjunction with the location of sun and shade on any selected date allowing for a more informed reservation decision. The user may also enter search criteria on a selection screen and be shown on the layout all lounge chairs or seating matching the search criteria. Also disclosed is a destination recommendation system which uses data from the lounge chair reservation system to make destination recommendations to users.

### CROSS REFERENCE TO RELATED APPLICATIONS

This applications claims priority to U.S. Provisional Application Ser. No. 62/719,889, filed Aug. 20, 2018, the entire contents of which are hereby incorporated by reference in their entirety.

### FIELD OF THE INVENTION

Disclosed herein is a lounge chair reservation system that provides users with a layout of the lounge chairs indicating availability and sun exposure at various times throughout the day. A destination recommendation engine is also disclosed.

### BACKGROUND OF THE INVENTION

Current reservation systems allow a user to select seats (e.g., for a concert), or reserve lounge chairs, and even to see the view from the seat or indicate if the view is obstructed. However, such seat reservation systems generally only provide a single view because the seats are indoors and the view or conditions are unlikely to change greatly from day to day. In addition, current lounge chair reservation systems, at most, indicate if a lounge chair has already been reserved or if it is available.

A user wanting to reserve a lounge chair may like to know other information, such as if the lounge chair is in the shade or the sun during the requested reservation time. However, current lounge chair reservation systems do not provide this type of information to users, and at most only provide the user with the availability of lounge chairs. Therefore, a need exists for a lounge chair reservation system capable of combining sun data with the layout of the lounge chairs to better inform the user about the conditions of the lounge chair during the requested reservation time. The system may even be able to use real time weather forecasts to alter the sun and shade data in real time on the layout.

### SUMMARY

Disclosed herein is a lounge chair reservation system used for reserving lounge chairs, or other seating options, at a destination. A layout screen allows a user to see the positioning of the lounge chairs in conjunction with the location of sun and shade on any selected date allowing for a more informed reservation decision. The user may also enter search criteria on a selection screen and be shown on the layout all lounge chairs or seating matching the search criteria. Also disclosed is a destination recommendation system which uses data from the lounge chair reservation system to make destination recommendations to users.

### BRIEF DESCRIPTION OF THE DRAWINGS

These and other advantages of the present invention will be readily understood with the reference to the following specifications and attached drawings.

FIG. 1 depicts a flowchart showing the method used to reserve a lounge chair using the system of the present invention.

FIG. 2 depicts a sample reservation screen used to make a lounge chair reservation.

FIG. 3 depicts a sample confirmation screen used to confirm a lounge chair reservation.

FIG. 4 depicts a system diagram showing the components of the lounge chair reservation system of the present invention.

FIG. 5 depicts a sample lounge chair search screen used to make a lounge chair reservation.

FIG. 6 depicts a sample selection screen showing lounge chair search results.

FIG. 7 depicts a sample destination recommendation search screen.

FIG. 8 depicts a sample destination recommendation results screen.

### DETAILED DESCRIPTION

Preferred embodiments of the present invention will be described herein below with reference to the accompanying drawings. In the following description, well-known functions or constructions are not described in detail because they may obscure the invention in unnecessary detail. While the present invention is generally directed to a lounge chair reservation system, the teachings may be applied to any reservation system where external factors, such as the sun or weather, may influence a user's reservation choice. Therefore, the teachings should not be construed as being limited to only a hotel with a lounge chair reservation system and can be applicable to cruises, beach resorts, etc. In addition, the lounge chair reservation system can be provided using any front end, allowing the same lounge chair reservation system to be provided through multiple booking sites, with each having access to real time data about reservations being made.

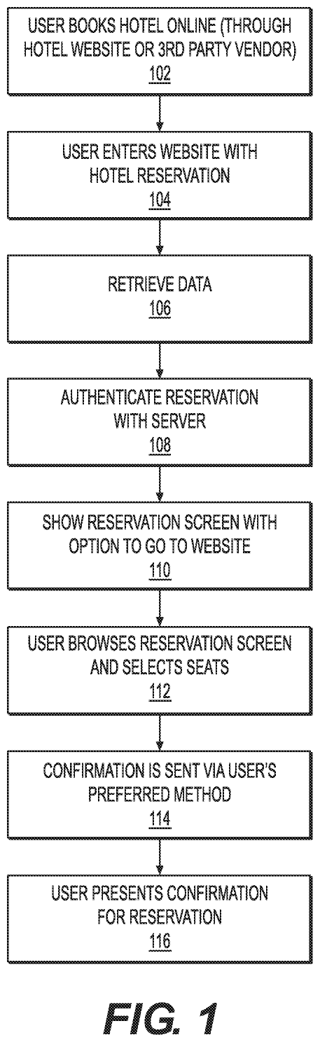

Referring first to FIG. 1, depicted is a flowchart showing the method used to reserve a lounge chair using the system of the present invention. As shown, a user first makes a hotel reservation online in step 102. This step is only required if the hotel, or other facility, requires that the lounge chairs can only be booked by current guests of the hotel. This can be accomplished through the hotel website itself or through third party vendors allowing hotel bookings as is known in the art.

In certain instances, this step may be omitted if it is not a requirement that the person making the reservation for the lounge chair is a guest of the hotel. For example, many hotels have a policy wherein users can utilize the facilities of the hotel for a nominal fee. Alternatively, as depicted in step 104, a user can enter an already existing itinerary number, for example, to initiate the lounge chair reservation system.

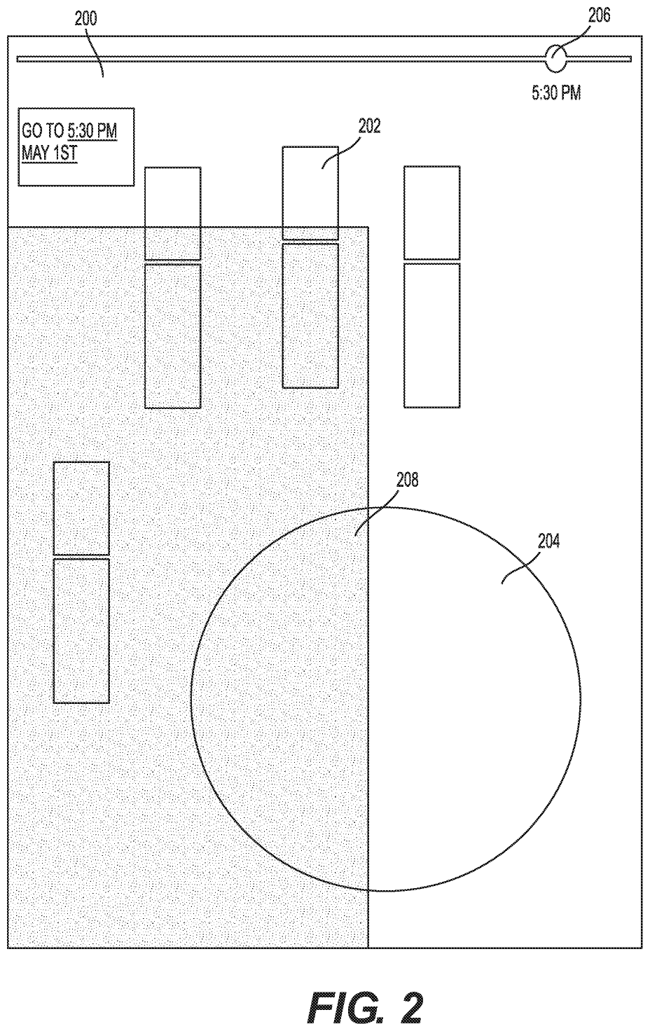

After the user has entered their reservation information or booked a hotel room, the user's information is retrieved in step 106 and verified in step 108. The lounge chair reservation system is then loaded for that particular hotel in step 110. First, the layout of the lounge chairs from the hotel is loaded into memory and displayed to the user. This can be accomplished via an embedded widget or displayed directly on the hotel's website. A sample reservation screen 200 that would be provided to the user is depicted in FIG. 2.

The layout data may also include additional information about the area surrounding the lounge chairs such as scenery. For example, the layout data may include the hotel layout, locations of restrooms, restaurants, bars, etc. which may influence the choice of lounge chair by the user. Also, the layout data may include the hotel and surrounding building and environmental structure, such as the location and height of trees, walls, or other structures, which may affect the sun and shadows cast in the environment. This additional environmental data also allows the lounge reservation system to better model the locations of the sun and shadows in the environment for the user.

As shown in FIG. 2, the location of all of the lounge chairs 202 is depicted in an overhead layout relative to the pool 204 or other body of water. And as already mentioned, other environmental structures, such as restroom locations, may also be depicted. Available lounge chairs 202 may be shown in a first color and unavailable lounge chairs 202 may be shown in a different color or with a marking, such as having an “X” placed on them.

A slide bar 206 may be provided across the top of the screen. By manipulating the slide bar 206, the user can see which lounge chairs are in the sun or in the shade. For example, at 5:30 PM, one of the depicted lounge chairs 202 would be completely in the shade 208, two of the lounge chairs would be partially in the shade 208, and one lounge chair would still be completely in the sun. Thus, by using the slide bar 206 to view the layout at different times of the day, a user wishing to make a lounge chair reservation can be better informed if the requested lounge chair would be in the sun or shade at the selected times.

In addition to slide bar 206, reservation screen 200 may also comprise a corresponding date bar allowing the user to change the date. This additional bar would allow a user to change the date and see the shade 208 information on different days of the week. For example, a user on a first date may book a first lounge chair 202 because it is in the sun all day. However, the user may reserve a second lounge chair on a second date because the conditions for the second lounge chair on the second date are more ideal (for the user) than the first lounge chair.

Reservation screen 200 may also include an option in which the user can move the lounge chair about the reservation screen 200. In particular, some hotels or facilities may allow the user to move the lounge chairs 202. By placing the lounge chair 202 at different positions and moving slide bar 206, the user can determine their ideal location for the lounge chair 202 by showing the sun and shade on reservation screen 200 over the lounge chair 202. Because the location of the sun is relatively at the same position in the sky year to year, the user can even use the system to change the year and not just the date to see the position of the sun. This feature may be useful in planning future trips or vacations.

Then, when making the reservation, the position information that the user selected would be saved along with the user's reservation. Staff of the hotel, before the user's arrival, could then place the reserved lounge chair 202 at the specified position in accordance with the user's instructions. This allows the hotel or facility to provide a unique service to the user not available with current lounge chair reservation systems.

Preferably, as depicted in FIG. 2, the shade 208 is depicted as a greyed or obscured area of the reservation screen 200. The shade 208 can be depicted in gradations levels of greyscale or color to inform the user about the level of shade 208 (light to total). Further, the intensity of the sun may also be indicated using a similar gradient system. Thus, by sliding the bar 206, the user can easily see the transition of both the sun and the shade over time as well as the relative intensity.

As an example, a user may want a lounge chair 202, near pool 204, that is in the sun only in the morning when the UV index is lower, and then in the shade 208 in the afternoon. By sliding slide bar 206, a user can easily observe which lounge chair or chairs 202 meet the specified criteria. And, if the lounge chair 202 is not in the exact desired position, a user can move the lounge chair 202 as already described. Further, as the slide bar 206 is changed, a display of the seasons, day, hour, minutes, etc. may also be changed on reservation screen 200 to enable a user to be better informed about the specifics of the reservation.

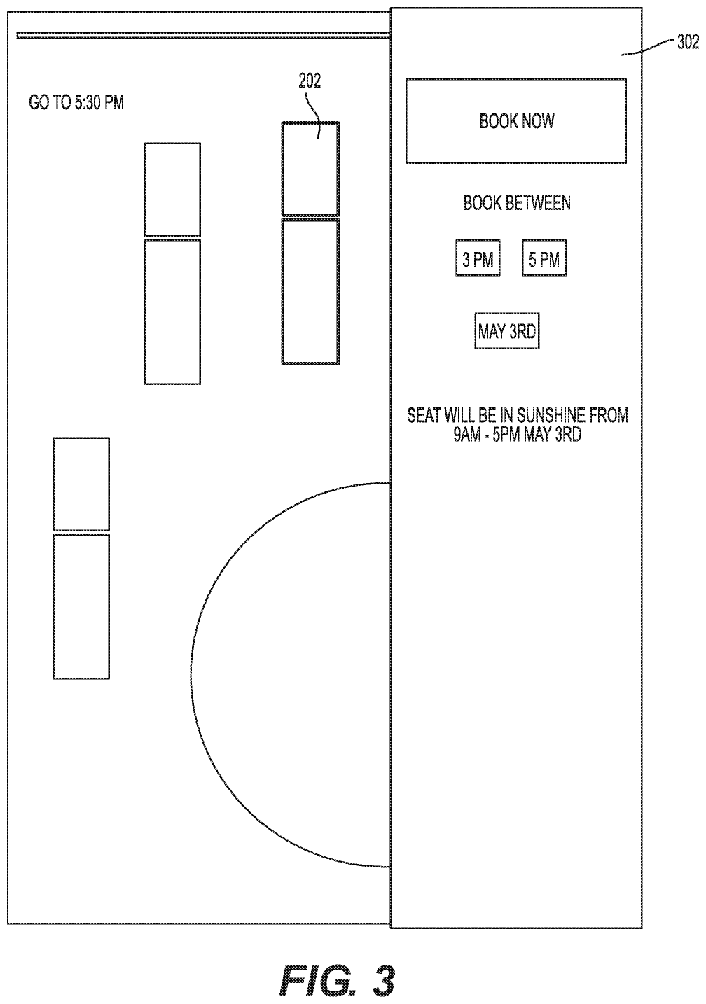

To reserve a lounge chair using reservation screen 200, a user simply clicks on the desired lounge chair(s) 202 as shown in FIG. 3. In this instance, the user has selected a lounge chair 202 which is shown with a bolded outline to indicate the user's selection. Multiple lounge chairs 202 can be selected for a single reservation.

Each lounge chair 202, or other item to be reserved on the layout, is preferably assigned a unique identifier such as a number, name, or letter. This allows a user to easily find their reserved lounge chair upon arrival, especially if the facility is large and/or confusing. Further, tagging the lounge chair 202 with a unique identifier allows hotel staff to more easily determine the location of a lounge chair or for the lounge chair 202 to be replaced (e.g., for damage, upgrades, etc.). Also, upon arrival, the user can be provided with a card, text message, email reservation confirmation, or any other form of communication, which lists the unique identifiers of the lounge chairs 202 that were reserved. This would enable the user to more easily settle any dispute over when and/or who is entitled to use each lounge chair 202.

However, the number of lounge chairs 202 available for each user may be limited by the number of hotel rooms and/or occupants of the hotel room to avoid the lounge chairs 202 from being overbooked. Additional chairs may be available at an additional cost. The user can then enter the requested hours and/or dates for the reservation using reservation box 302 provided on the screen. The reservation box 302 may provide the user with additional information about the selected lounge chair 202. For example, as depicted in FIG. 3, the text indicates that the selected lounge chair 202 “will be in sunshine from 9 AM-5 PM” on May 3^{rd}. This information is preferably updated in real time as the user inputs the requested dates and times. Once the user has entered all the required information, the user can click “Book Now” to make the reservation.

In some embodiments, the user may simply enter specified criteria for the reservation and the lounge chair reservation system may make selections automatically or the user according to the specified criteria. For example, the user may provide the lounge chair reservation system with one or more dates, number of chairs required, time period, location, sun/shade requirements, etc. and then reservation screen 200 would display and automatically select lounge chairs 202 according the specified criteria. This automatic selection would especially be beneficial to users not familiar with the layout of the hotel.

Returning back to FIG. 1, the user browses the layout and selects the desired seating location as has already been described with reference to FIGS. 2 and 3 in step 112. A confirmation is then sent to the user in step 114 using the user's preferred method. If the lounge chair reservation was made in conjunction with a hotel reservation, both of the reservations are preferably stored in association with each other. Then when a user later presents their lounge chair reservation or hotel reservation, either piece of information can be used to confirm both reservations in step 116.

In FIGS. 2 and 3, an overhead layout was chosen for reservation screen 200 because it easily conveys to the user the location of lounge chairs 202 relative to pool 204 and shade 208. However, it should be apparent that a more complicated layout, such as a 3D virtual reality layout could also be used. In this instance, a 3D virtual world can be produced and then the sun can be modeled at different selected times to not only show the user the location of the shade 108, but other information such as if the sun would be in the user's eyes, the direction of the sun, the intensity of the sun and/or shade 208. In such a system, a “view” from each lounge chair at different times of the day could be produced and shown to the user (e.g., a view of the lounge chair 202 or a view from the lounge chair 202). This view could be provided instead of, or in addition to, the overhead layout presented in reservation screen 200. The user could also use slide bar 206 in the 3D virtual reality layout if desired.

The reservation system may also incorporate other data sources besides the layout and sun position. For example, real time weather and temperature information may be incorporated into the reservation screen 200. For example, if, on a certain day, it is known from weather data that it is cloudy, the reservation screen 200 shown in FIG. 2 could be altered to indicate that all lounge chairs 202 would be in the shade 208 for the day because of current weather conditions (e.g. extreme heat).

Weather data can also be used to provide updates to users about reservations. For example, if it is known that a user booked a lounge chair reservation intended to be in the sun all day, the user could later be sent an email or other indicator stating that current weather patterns would affect the previously provided information. Alternatively, if the temperature forecast for the day has changed, the user can be provided with the updated temperature and a selection to cancel the reservation.

For example, the text in FIG. 3 indicates to the user that the seat would be in the sunshine from 9 AM-5 PM based upon its location. However, if it is later determined that it would be cloudy on May 3^{rd} or too cold, the user may be provided with an update via text message, email, or another form of communication about the lounge chair reservation. The user may also be presented an option to move the lounge chair 202 to a covered location by again using reservation screen 200.

The lounge chair reservation system of the present invention may also make use of historic weather information to better inform the user. For example, historic weather information databases are well known in the art. The historical weather information known for May 3^{rd}, for example, may be used to provide the user with a percentage chance that the requested lounge chair would actually be in the sun (e.g., 80% historical chance of sun, 10% chance of clouds, 10% chance of rain, etc.). Thus, by using both current weather information weather and historical weather information databases, the user can be better informed about their lounge chair reservation at the time of making the reservation in contrast to prior art systems which only indicate the availability or unavailability of the lounge chair to the user.

If users do not show up for their reservation, the lounge chair may be held for a predetermined period of time (e.g., 30 minutes) before the lounge chair 202 is returned to the reservation system. However, if a user has prepaid for their reservation, the lounge chair 202 may stay reserved for the entire day, regardless of whether or not the user makes use of the lounge chair.

In the event of a missed reservation, the user may be sent a reminder email, text message, or phone call. If the user responds, the lounge chair 202 may be held for an additional period of time greater than the predetermined period of time (e.g., 1 hour or more) because the user has indicated continued interest in the reservation.

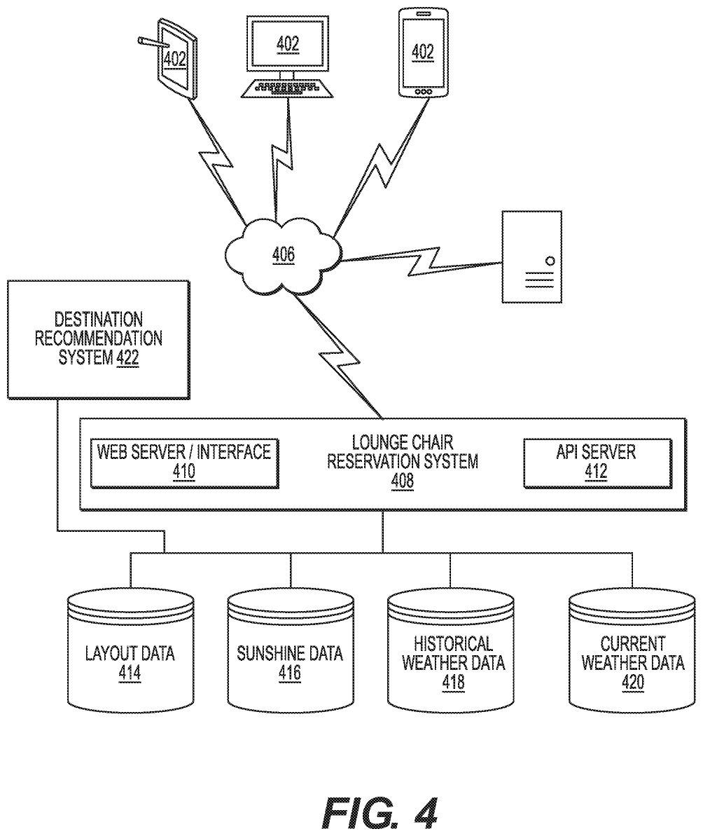

The system architecture used to enable the lounge chair reservation system of the present invention are depicted in FIG. 4. Client device 402 is the device controlled by the user and used to make the lounge chair reservation and/or the hotel reservation. For clarity, only a single client device 402 is depicted. However, it should be apparent that every user of the reservation system has access to one or more client devices 402 that can be used to make a reservation with the lounge chair reservation system of the present invention.

The client device 402 may be a mobile device, such as a tablet or cell phone, or a home computer. The client devices 402 are in communication with one or more third party servers/APIs (application program interfaces) 404 over network 406. Network 406 is any known combination of the internet and/or local area networks (LANs) that facilitate communication of client devices 402 with third party servers/APIs 404.

The lounge chair reservation system 408 generally comprises a web server 410 that provides the web interface (e.g., reservation screen 200) and an API server 412 that receives and responds to queries from third party servers/APIs 404 over network 406. The same lounge chair reservation system 408 can be used to provide a similar service for a plurality of hotels. For each hotel location, the layout data for the lounge chairs is stored in layout database 414 and the local sun data is stored in sunshine database 416. Then, when a query is made from a third party server 404, a lounge chair reservation screen particular to any hotel or pool can be created on the fly using the retrieved layout and sunshine data.

Further, by having the layout data 414 and sunshine data 416 stored at lounge chair reservation system 408, any updates to lounge chair placement only need to be made to layout data 414 instead of at a plurality of different locations.

Moreover, as already described, additional data sources, such as historical weather database 418 and current weather data 420 may be used to enhance the information provided through lounge chair reservation system 408.

The present invention also provides a destination recommendation system 422 which utilizes sunshine data 416, historical weather data 418, and current weather data 420 to provide destination recommendations to travelers based on vacation selection criteria which will be described later.

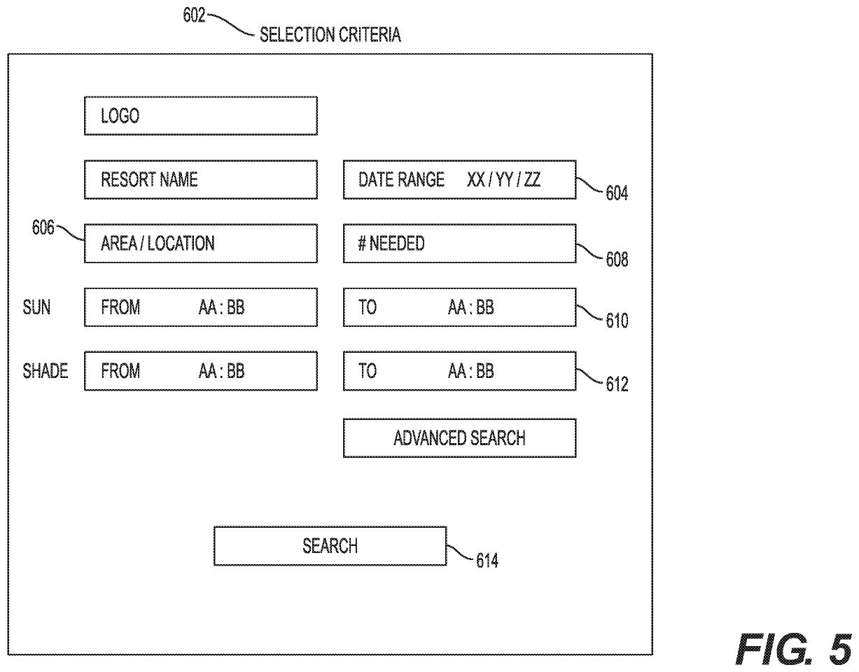

Referring next to FIG. 5, depicted is an alternate selection screen/widget 602 which provides an alternate method to reserve a lounge chair. Selection screen 602 is used when a user wishes to be provided with recommended lounge chairs or other seating options according to a plurality of selection criteria. As shown, the top or background of the selection screen 602 preferably comprises an area for branding or other identification information (hotel name, resort name, etc.). The user enter the dates for the lounge chair reservation using date field 604. Date field 604 may allow a user to enter a date, may be populated with the current date, or may provide a dropdown list or a calendar popup which allows for easy selection.

Area/location field 606 allows a user to select an area of the hotel or resort in which the user desires to rent or reserve the lounge chair. Sample selections may include pool area, rooftop, bar adjacent, beachfront, etc. A user uses quantity field 608 to enter the number of lounge chairs required for the reservation.

Next, selection screen 602 provides two additional fields unique to the present invention which make use of sunshine data 416, historical weather data 418, and current weather data 420. In the sun field 610, a user enters the time of day in which they would like the lounge chairs to be in the sun whereas in the shade field 612 a user enters the time of day they would like to be in the shade. Because the lounge chair reservation system 408 has access to sun, shade, and weather data, it can predict or model which lounge chairs are likely to be in the sun and which lounge chairs are likely to be in the shade at all times of day.

A user can also click on advanced search option 614 to be provided with additional selection criteria not available on selection screen 602. Additional options may include handicap accessibility, pet friendly, child friendly, etc.

After entering the requested information on selection screen 602, a user hits search button 614. Lounge chair reservation system 408 begins the search by loading the layout data 414 for the selected resort and location. Using the sunshine data 416 and historical weather data 418, the lounge chair reservation system 408 then determines, for each lounge chair, the range of times for sun and the range of times for shade. Also, using the historical weather data 418 (e.g., year to year), the lounge chair reservation system 408 also determines a confidence level for the accuracy of the prediction.

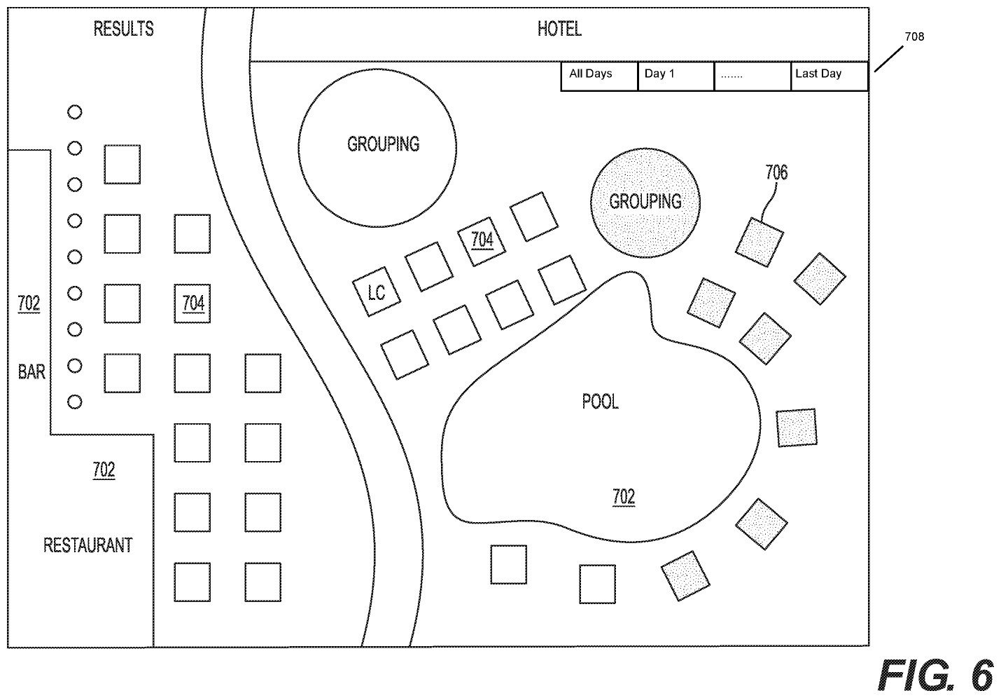

A sample result screen is depicted in FIG. 6. As shown, a graphical depiction of the selected area is loaded using the layout data 414 showing all relevant points of interest 702 such as a pool, restaurant, walkways, bars, beach, etc. An outline of the placement of each lounge chair 704 is also shown. Each lounge chair 704 may be depicted by a simple outline, a drawing of the lounge chair, or an actual picture. A subset 706 of the lounge chairs 704 are highlighted or shown differently from the other lounge chairs. The subset 706 are the lounge chairs which most closely (or 100%) meet the criteria entered on selection screen 602. In some embodiments, the highlighted color used may represent how closely the lounge chair meets the criteria for the selected dates. For example, green may be used as the highlight color for lounge chairs 704 which meet 100% of the criteria, blue may be used for lounge chairs 704 which meet <100% but greater than 85%, and red may be used for lounge chairs 704 which meet <85% but >70%. If the match is less than 70-75%, it is unlikely that a user would be interested in reserving the lounge chair. However, similar to FIG. 2, a user can select any lounge chair not highlighted for reservation also.

A plurality of tabs 708 may be provided on the results screen allowing a user to select the ability to view the search results on different dates. For example, during busy times of the year, the same lounge chairs 704 may not be available for the entire date range. A user can select a tab 708 to view the availability for each of the days in the date range shown in date field 602. A user can make a first selection on the “All Dates” tab 708 which can be used to select the same lounge chairs 708 for all dates. Specific dates can then be modified by selecting on the desired date tab 708 and modifying that selection on the particular date of lounge chairs 706.

In another embodiment, the selection criteria screen 602 may function as a data entry screen and the lounge chair reservation system 408 may automatically reserve lounge chairs which meet the specified criteria, requiring little to no further user selection.

The same layout data 414, sunshine data 416, historical weather data 418, and current weather data 420 may also be utilized to provide destination recommendation system 422. As should be obvious, lounge chair reservation system 408 is used after a user has already chosen a destination hotel or resort. However, many individuals are not travel savvy and may not know about specific destinations. Other individuals may also be picky about temperature during vacation or amenities. Destination recommendation system 422 alleviates many of these problems.

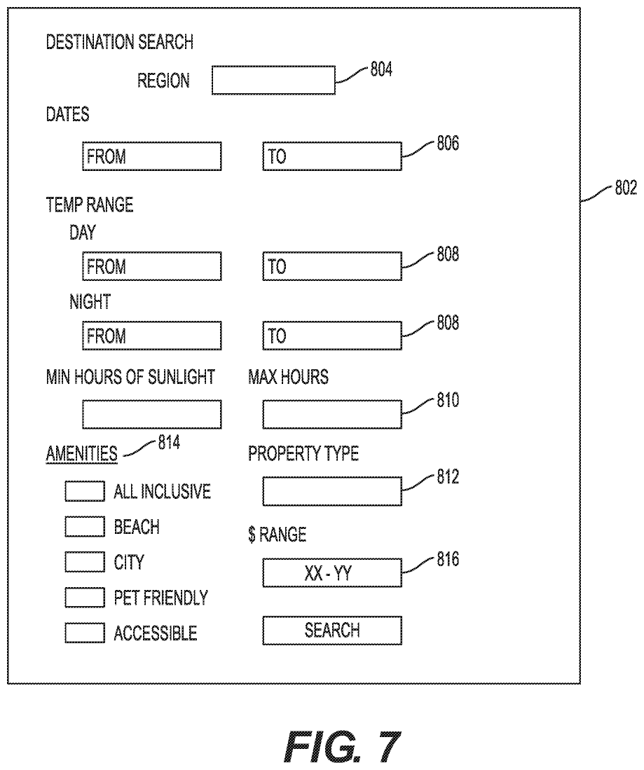

A sample destination search screen 802, which serves as a front end input screen to destination recommendation system 422, is depicted in FIG. 7. A region field 804 can be used to select a region, state, geography type, or country that the user is interested in. However, a user can leave this field blank if desired. Date fields 806 allow the user to input their desired travel dates (or select a month).

Temperature fields 808 allow a user to select a desired day temperature range and night temperature range that they would like at their destination. During search, this information is sourced from historical weather data 418. As an example, some users may want constant temperatures for day and evening whereas other users may prefer a drastic contrast between day and night.

Sunlight field 810 allows a user to select how many hours of the day that they would preferably have sunlight or a preferred time range for sunlight availability. This information is sourced from sunshine data 416 during search.

Cost range field 816 allows a user to set a per night cost range that they are willing to pay. This information may either be provided in real time (e.g., by querying a room reservation system) or based on historical pricing information collected by various websites.

Amenities selection 814 allows a user to select various options that they would like during vacation such as all inclusive, pet friendly, handicap accessible, etc. Amenities may either be presented on

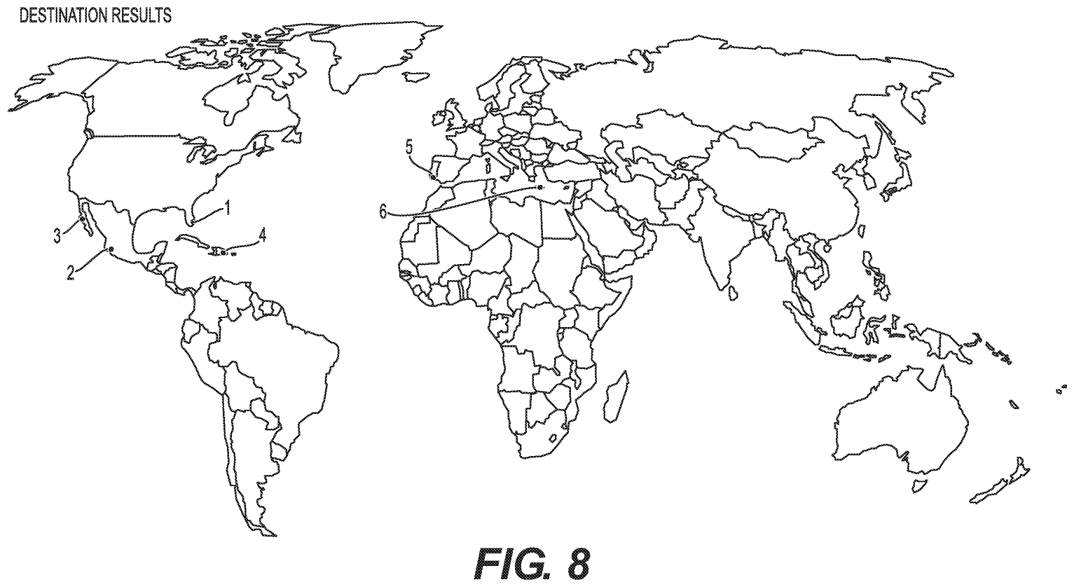

An example destination results screen 902 is depicted in FIG. 8. In this embodiment, a world (or regional) map is depicted and the results of the search are ranked. For example (1) is shown as being in Florida, (2) is shown as being in Mexico, etc. These are sample results that meet the selection criteria entered in destination search screen 802. In a desktop environment, if a user hovers their mouse over each results, additional information can be seen such as location, price range, etc.

If a user clicks on any of the search results, the user may be provided with additional information on an information screen or taken to a site for booking. In this way, the destination recommendation system 422 can be used to direct users to room reservations, and possibly to eventual bookings through lounge chair reservation system 408.

It should be obvious that lounge chair reservation system 408 can be modified to accommodate reservations for any system in which a layout is known and users which to utilize sunshine or shade data as a criteria. For example, at a camping reservation site, a user may be able to request different campsites which have a specific amount of light or shade during the day. Or, the system may be able to used to reserve different types of items, different than lounge chairs 702, which may also be present. For example, cabanas, tables, lounge chair groupings, are all other types of items for which reservations may be available for.

1. A method of scheduling a reservation comprising:
loading layout data of a reservation area, wherein the layout data comprises a location of a plurality of lounge chairs and a identifier for each lounge chair;
receiving selection criteria from a user for the reservation, wherein the selection criteria includes date selection, a sunshine time range and a shade time range,
wherein the sunshine time range and the shade time range do not overlap;
for each lounge chair on the date selection, calculating a sun timing that each lounge chair is in the sun and a shade timing that each lounge chair is in the shade;
comparing the receive sunshine time range and the shade time range to the sun timing and the shade timing for each lounge chair to determine a subset of lounge chairs that match the selection criteria;
displaying, on a layout screen, the layout of the reservation area with the matching lounge chairs shown in a highlighted color;
receiving, from the user, a selection of at least one lounge chair from the matching lounge chairs;
creating a lounge chair reservation for the user based on the selection; and
providing confirmation to the user about the lounge chair reservation.

2. The method according to claim 1, wherein the lounge chairs not shown in the highlighted color cannot be selected by the user for the lounge chair reservation.

3. The method according to claim 1, further comprising:
before receiving the selection from the user, providing a confidence score to the user for each matching lounge chair based upon historical weather data.

4. The method according to claim 3, wherein a warning is sent to the user a predetermined period before the date selection if current weather forecast data has affected the confidence score.

5. The method according to claim 3, further comprising:
providing a cancellation option to the user if the confidence score has dropped below a predetermined threshold.

6. The method according to claim 1, wherein a maximum number of matching lounge chairs that can be reserved by the user is limited by a number of hotel rooms reserved by the user.

7. The method according to claim 1, wherein a maximum number of matching lounge chairs that can be reserved by the user is limited by a sleeping capacity of hotel rooms reserved by the user on the date selection.

8. A method for performing lounge chair reservations, the method comprising:
loading, from a layout database, layout data about a reservation area,
wherein the layout data includes position information about a plurality of lounge chairs, amenity locations, and recreation locations;
loading, from a sunshine database, sunshine data and shade data for the reservation area on a selected date;
displaying, on a display screen, the layout data for the reservation area;
superimposing, on the layout data, a shade mask for all areas of the reservation area in shade at a selected time,
wherein a user can change the selected time through use of a slider bar provided on the display screen and
wherein changing of the selected time changes the shade mask;
receiving a selection of one or more lounge chairs from the user; and
creating a lounge chair reservation for the user based on the selection.

9. The method of claim 8, wherein the shade mask is displayed in translucent gray.
